(19) United States
(12) Patent Application Publication
(10) Pub. No.: US 2005/0221663 A1
(43) Pub. Date: Oct. 6, 2005

(54) Cable fixing apparatus

(75) Inventors: Kenichiro Matsumoto, Hino-shi (JP); Eiichi Arashiro, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/956,021

(22) Filed: Oct. 4, 2004

(30) Foreign Application Priority Data
Apr. 2, 2004 (JP) 2003-110387

(51) Int. Cl. H01R 11/00

(52) U.S. Cl. 439/502

(57) ABSTRACT

Two signal lines are included among a plurality of coated signal transmission lines coupled at one end to a connector. The two signals lines are used for transmission of differential signals. The two signal lines are bundled and in contact with each other, and are coupled to the connector in this mutual contact state.

### CROSS-REFERENCE TO RELATED APPLICATIONS

This application is based upon and claims the benefit of priority from prior Japanese Patent Application No. 2004-110387, filed Apr. 2, 2004, the entire contents of which are incorporated herein by reference.

### BACKGROUND OF THE INVENTION

1. Field of the Invention

The present invention relates to a cable fixing apparatus for fixing a cable to a connector, the cable including signal lines used for transmitting high-speed differential signals between substrates. More specifically, the present invention relates to a cable fixing apparatus that enables a pair of differential signal lines to be coupled to the connector in a mutually-contact and bundled state.

2. Description of the Related Art

In recent years, the speed of serial transmission lines has been remarkably increased, as can be seen from the wide use of USB2.0 and IEEE1394. The serial transmission lines for these interfaces have been provided mainly on substrates. Since the transmission loss of the serial transmission lines has become a problem in accordance with an increase in signal transmission speed, the serial transmission lines are covered with a material having a low dielectric constant and thus enable signal transmission with reduced loss.

When high-speed differential serial signals are transmitted through a cable, its signal degradation must be suppressed to a minimum. For this purpose, the cable in use is controlled such that its impedance characteristic is constant throughout the length. In the case of USB2.0, for example, the impedance characteristic of the signal lines is fixed at 90Ω. To provide a constant impedance characteristic, the distance between the signal lines through which a differential pair of signals are transmitted must be uniform throughout the length of the cable. For this purpose, the signal lines are bundled together by use of a shielding material, or a twisted pair of signal lines are used.

FIG. 3 shows how signal lines adapted for high-speed serial transmission are connected to a substrate. As shown in FIG. 3, the connection is performed by a cable 101 which includes signal lines that are spaced apart by a predetermined distance, and a connector 103 adapted for connection to the substrate. In many cases, there are naked signal line portions 102 (wherein the distance between the adjacent signal lines is not constant) between the cable 101 and the connector 103. Such naked signal line portions 102 are inevitably produced for reasons attributable to manufacture. The naked signal line portions 102 include naked portions of a differential pair of signal lines 120 and 121.

FIG. 4 illustrates the impedance characteristic of a cable. In FIG. 4, the abscissa represents the length of the cable, and the ordinate represents an impedance. An impedance mismatch occurs in the naked signal line portions 102, where the signal lines are not bundled. The impedance curve shows a high peak 106 at the positions corresponding to the naked signal line portions 102.

Jpn. Pat. Appln. KOKAI Publication No. 2001-352645 discloses how to fix signal lines by use of a fixing block, with the signal lines being spaced apart by a predetermined distance.

### BRIEF SUMMARY OF THE INVENTION

As described above, the conventional cable fixing apparatus has problems in that an impedance mismatch occurs in the naked signal line portions where the signal lines are not spaced by a constant distance. In the naked signal line portions, therefore, the signals transmitted through the signal lines are attenuated in amplitude, and are degraded after undergoing reflection. As a result, the signals that have passed through the naked signal line portions do not satisfy the characteristics required of them.

The technology described in Jpn. Pat. Appln. KOKAI Publication No. 2001-352645 uses a fixing block, and the casing is inevitably large in size, resulting in a high manufacturing cost.

The present invention has been conceived in an effort to solve the above problems, and an object of the invention is to provide a cable fixing apparatus which bundles a differential pair of signal lines by use of a desired structure, occupies little space, can be manufactured with a low cost, provides a constant impedance characteristic throughout the length of the cable, and suppresses the signal degradation to a possible extent.

According to one aspect of the present invention, there is provided a cable fixing apparatus which permits a pair of differential signal lines, which are included among a plurality of surface-coated signal transmission lines connected at one end to a connector and which are used for transmission of differential signals, to be bundled and in contact with each other and coupled to the connector in this state.

The paired signal lines are in contact with each other at the bundled portion and are connected to the connector in this contact state. With this structure, the impedance characteristic is as flat (constant) as possible throughout the length of the cable, and the signal degradation can be suppressed to be a minimum.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing how the signal lines are when a cable fixing apparatus according to an embodiment of the present invention is used.

FIG. 2 illustrates the impedance characteristic a cable shows when the cable fixing apparatus of the embodiment of the present invention is used.

FIG. 3 is a schematic diagram showing how the signal lines are when a conventional cable fixing apparatus is used.

FIG. 4 illustrates the impedance characteristic a cable shows when the conventional cable fixing apparatus is used.

### DETAILED DESCRIPTION OF THE INVENTION

An embodiment of the present invention will now be described, referring to the accompanying drawings.

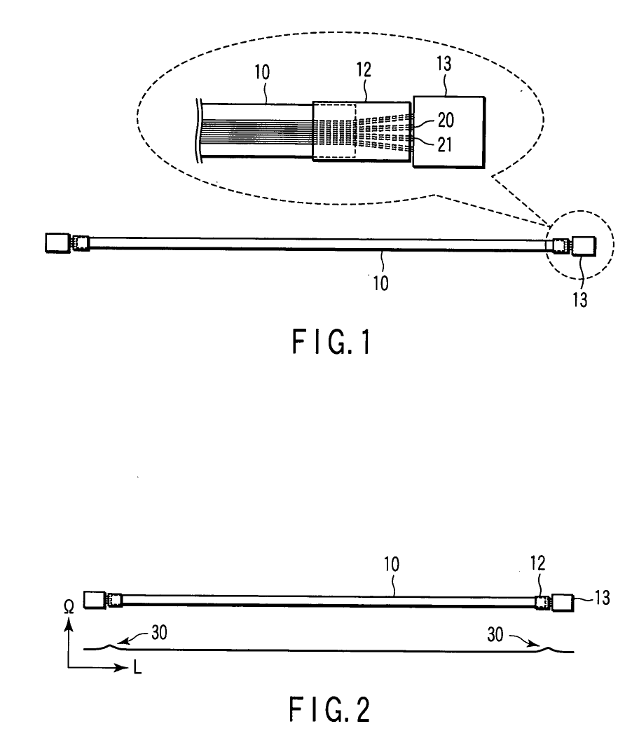

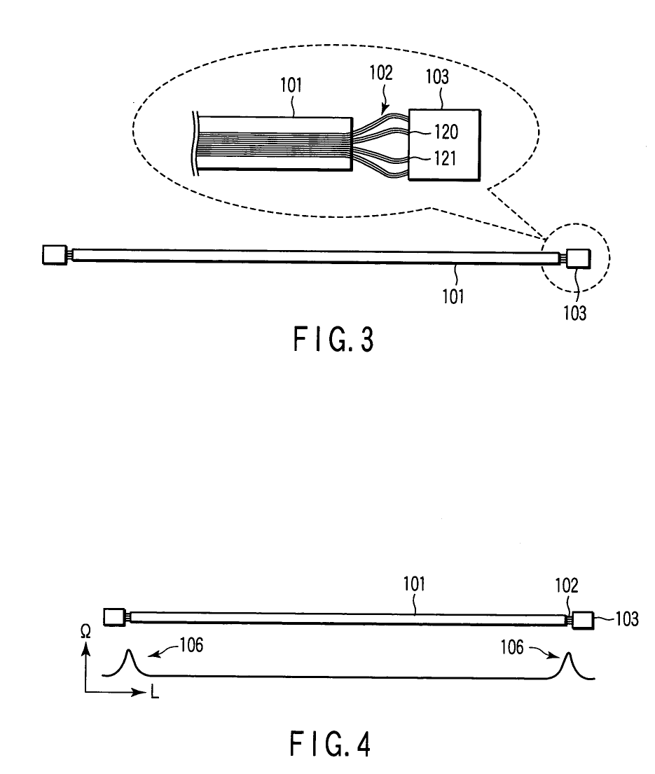

FIG. 1 is a schematic diagram showing how the signal lines are when a cable fixing apparatus according to an embodiment of the present invention is used.

The cable fixing apparatus uses a cover member 12 to bundle (or bound) naked and unbundled (or unbound) signal lines, which are located between a cable 10 (wherein signal lines are covered with a flat shield member or the like) and a connector 13. This cover member 12 is a heat-shrinkable tube, for example. Where four of the signal lines of the cable 10 are bundled (that is, a differential pair of signal lines 20 and 21, a power supply line and a ground line are bundled), at least signal lines 20 and 21 must be bundled together. To be more specific, it is preferable that signal lines 20 and 21 be as close as possible to each other, as they are in the cable 10.

Signal lines 20 and 21 are bundled by the cover member 12 in such a manner that signal lines 20 and 21 are spaced from each other only by the distance determined by their coating members (e.g., insulating vinyl members). As a result, each of signal lines 20 and 21 has a constant width and provides a constant impedance throughout the length. Hence, the signal degradation in each signal line is suppressed to be a minimum. Where two or more cables 10 are provided, a differential pair of signal lines of each cable 10 are bundled as above. As long as the signal lines of the differential pair are bundled, the other signals can be arranged freely.

Normally, the cover member 12 (e.g., a heat-shrinkable tube) is used for covering the extra shield member at the end of a cable. In the embodiment of the present invention, the cover member 12 is used not only for covering the extra shield member but also for bundling and fixing the naked signal line portions described above.

FIG. 2 is a schematic diagram illustrating the impedance characteristic the cable 10 shows when the cable fixing apparatus of the embodiment of the present invention is employed. In FIG. 4, the abscissa represents the length of a cable, and the ordinate represents an impedance. As can be seen from this, the impedance mismatch 30 at the naked signal line portions is suppressed to be a minimum by bundling the naked signal line portions by means of the cover member 12 (compare FIG. 2 with FIG. 4, which illustrates the case of the conventional art).

The impedance mismatch at the naked signal line portions may be decreased if the naked signal line portions are short. However, the naked signal line portions require a certain length (normally, 30 mm or so) so as to enable connection between the cable 10 and the connector 13. (The required length is attributable to the manufacture.) If the signals transmitted through the signal lines are high in transmission speed, the length of the naked signal line portions has critical effects on the signal quality.

The cable fixing apparatus of the embodiment of the present invention permits the naked signal line portions to have a certain length. In addition, the cable and the connector 13 can be connected before the naked signal line portions are covered with the cover member 12. This is very advantageous when the cable fixing apparatus is applied to practice. It should be noted that the cover member 12 need not be a heat-shrinkable material and may be made of a shield material, such as aluminium. Where the cover member 12 is formed of such a shield material, a cable not only shows a flat (constant) impedance characteristic throughout the length but also improves in anti-noise characteristic.

The present invention is not limited to the embodiment described above and can be reduced to practice, with its structural elements modified in various manners without departing from the spirit and scope of the present invention. In addition, the structural elements described above may be combined in such a manner as to make other inventions. For example, one or more structural elements may be omitted when the present invention is reduced to practice.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A cable fixing apparatus wherein two signal lines, which are included among a plurality of surface-coated signal transmission lines coupled at one end to a connector and which are used for transmission of differential signals, are bundled and in contact with each other and connected to the connector in a mutual contact state.

2. A cable fixing apparatus according to claim 1, wherein said two signal lines are bundled by use of a heat-shrinkable tube interposed.
